(19) United States
(12) Patent Application Publication
(10) Pub. No.: US 2025/0354429 A1
(43) Pub. Date: Nov. 20, 2025

(54) METHOD FOR ICE PREVENTION VIA TELEMETRY AND OTHER DATA ELEMENTS

(71) Applicant: GM Global Technology Operations LLC, Detroit, MI (US)

(72) Inventors: Matthew Edward Gilbert-Eyres, Rochester Hills, MI (US); Russell A. Patenaude, Macomb Township, MI (US); Alec M. Wuorinen, Columbus, OH (US); Craig Thomas Douglas, Pflugerville, TX (US)

(73) Assignee: GM Global Technology Operations LLC, Detroit, MI (US)

(21) Appl. No.: 18/664,698

(22) Filed: May 15, 2024

(51) Int. Cl. E05F 15/71; B60Q 9/00; B60S 1/08; G01W 1/06

(52) U.S. Cl. CPC E05F 15/71; B60Q 9/00; B60S 1/0818; G01W 1/06; E05Y 2900/534; E05Y 2900/55

(57) ABSTRACT

A method for ice prevention includes detecting that a vehicle is parked in an unenclosed location and receiving sensor data for the vehicle. The sensor data indicates a current environment of the vehicle and a predicted environment of the vehicle. The method also includes determining, based on the sensor data, whether ice prevention for the vehicle is needed to prevent ice from forming on the vehicle. When ice prevention for the vehicle is needed, the method also includes determining whether a power source of the vehicle exceeds a threshold, executing an ice mitigation model to generate an ice mitigation strategy for the vehicle, and initiating the ice mitigation strategy for the vehicle while the vehicle is parked.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to systems and methods of preventing ice formation on a vehicle. Generally, when ice forms on a vehicle, users must use a combination of time and effort to remove the ice from the vehicle. For example, users are often required to scrape ice manually from windows, a windshield, and other vehicle surfaces to allow the user to gain access to the vehicle and/or see out of the vehicle windows and/or windshield during use of the vehicle. Such scraping may result in damage to the windows, the windshield, or other vehicle surfaces and, further, may damage other vehicle systems associated with such areas of the vehicle such as, for example, windshield wipers, trim components, and door handles. Additionally or alternatively, a user may start the vehicle and wait for the ice to melt, thereby delaying departure for the user.

While the foregoing methods adequately remove ice from a vehicle, risk of damage to the vehicle is ever present. Further, even if such methods do not cause damage to the vehicle or vehicle systems, extra time and effort are spent by the user, thereby delaying use of the vehicle.

### SUMMARY

One aspect of the disclosure provides a computer-implemented method for ice prevention via telemetry and other data elements that when executed on data processing hardware causes the data processing hardware to perform operations that include detecting that a vehicle is parked in an unenclosed location, receiving sensor data for the vehicle, the sensor data indicating a current environment of the vehicle and a predicted environment of the vehicle, and determining, based on the sensor data, whether ice prevention for the vehicle is needed to prevent ice from forming on the vehicle. When ice prevention for the vehicle is needed, the operations also include determining whether a power source of the vehicle exceeds a threshold, executing an ice mitigation model to generate an ice mitigation strategy for the vehicle, and initiating the ice mitigation strategy for the vehicle while the vehicle is parked.

Implementations of the disclosure may include one or more of the following optional features. In some implementations, the operations further include, after determining that ice prevention for the vehicle is needed, generating, for output to a user of the vehicle, a notification indicating that ice prevention for the vehicle is needed. In these implementations, the notification may be displayed on a screen of a user device in communication with the data processing hardware. Additionally or alternatively, the notification may be displayed on a user interface of the vehicle.

In some examples, the sensor data for the vehicle includes one or more of an outside temperature, a cabin temperature of the vehicle, precipitation, cloud coverage, dew point, humidity, location, wind direction, and third party traffic data. In some implementations, the predicted environment of the vehicle includes weather predictions for a location of the vehicle while the vehicle is parked. In some examples, the ice mitigation strategy includes cycling one or more of windows of the vehicle, wiper blades of the vehicle, door handles of the vehicle, and a cover of the vehicle.

In some implementations, executing the ice mitigation model to generate the ice mitigation strategy for the vehicle includes receiving one or more of a schedule of a user of the vehicle, a start time of precipitation for a location of the vehicle while the vehicle is parked, and an end time of the precipitation for the location of the vehicle while the vehicle is parked. In some examples, executing the ice mitigation model to generate the ice mitigation strategy for the vehicle is based on determining that the power source of the vehicle exceeds the threshold. In some implementations, the operations further include, when the power source of the vehicle does not exceed the threshold, deferring execution of the ice mitigation model.

Another aspect of the disclosure provides a system for ice prevention via telemetry and other data elements that includes data processing hardware and memory hardware in communication with the data processing hardware. The memory hardware stores instructions that when executed by the data processing hardware cause the data processing hardware to perform operations that include detecting that a vehicle is parked in an unenclosed location, receiving sensor data for the vehicle, the sensor data indicating a current environment of the vehicle and a predicted environment of the vehicle, and determining, based on the sensor data, whether ice prevention for the vehicle is needed to prevent ice from forming on the vehicle. When ice prevention for the vehicle is needed, the operations also include determining whether a power source of the vehicle exceeds a threshold, executing an ice mitigation model to generate an ice mitigation strategy for the vehicle, and initiating the ice mitigation strategy for the vehicle while the vehicle is parked.

This aspect may include one or more of the following optional features. In some implementations, the operations further include, after determining that ice prevention for the vehicle is needed, generating, for output to a user of the vehicle, a notification indicating that ice prevention for the vehicle is needed. In these implementations, the notification may be displayed on a screen of a user device in communication with the data processing hardware. Additionally or alternatively, the notification may be displayed on a user interface of the vehicle.

In some examples, the sensor data for the vehicle includes one or more of an outside temperature, a cabin temperature of the vehicle, precipitation, cloud coverage, dew point, humidity, location, wind direction, and third party traffic data. In some implementations, the predicted environment of the vehicle includes weather predictions for a location of the vehicle while the vehicle is parked. In some examples, the ice mitigation strategy includes cycling one or more of windows of the vehicle, wiper blades of the vehicle, door handles of the vehicle, and a cover of the vehicle.

In some implementations, executing the ice mitigation model to generate the ice mitigation strategy for the vehicle includes receiving one or more of a schedule of a user of the vehicle, a start time of precipitation for a location of the vehicle while the vehicle is parked, and an end time of the precipitation for the location of the vehicle while the vehicle is parked. In some examples, executing the ice mitigation model to generate the ice mitigation strategy for the vehicle is based on determining that the power source of the vehicle exceeds the threshold. In some implementations, the operations further include, when the power source of the vehicle does not exceed the threshold, deferring execution of the ice mitigation model.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of a system for ice prevention via telemetry and other data elements.

FIG. 2 is a schematic view of example components of the system of FIG. 1.

FIG. 3 is a schematic view of an example device in communication with an ice prevention system of a vehicle.

FIGS. 4A-4C are example ice mitigation strategies generated by the system of FIG. 1.

FIG. 5 is a flowchart of an example arrangement of operations for a method of ice prevention via telemetry and other data elements.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

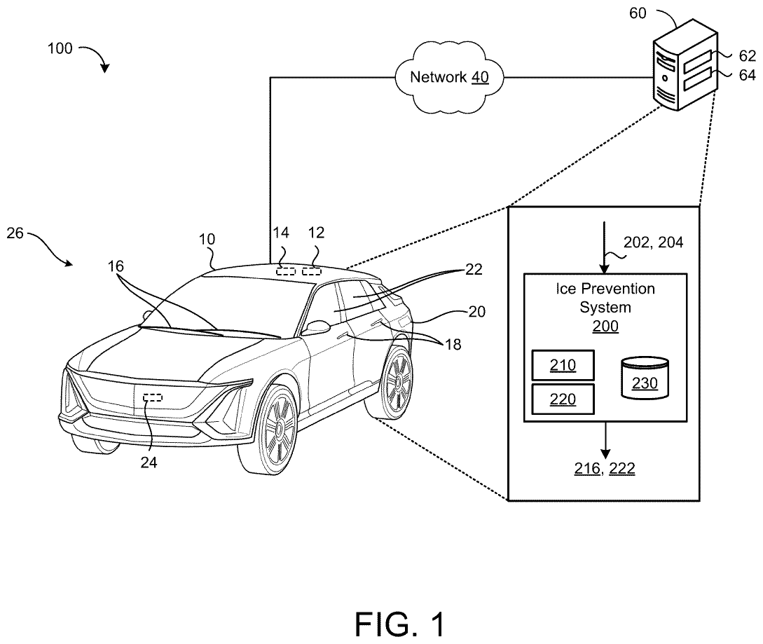

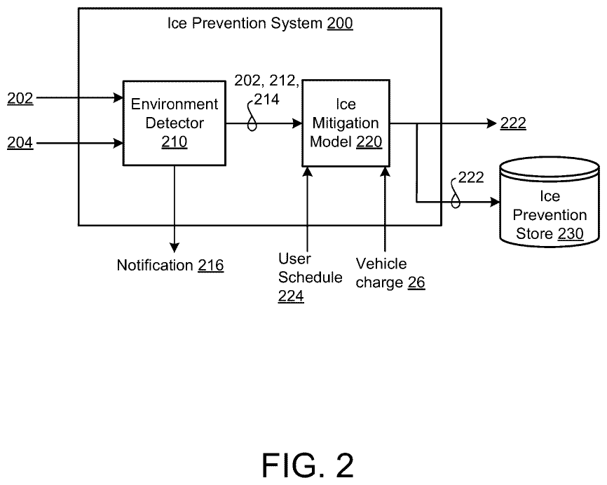

Referring to FIG. 1, in some implementations, a system 100 includes a vehicle 10 and/or a remote system 60 in communication with the vehicle 10 via a network 40. The vehicle 10 and/or the remote system 60 execute an ice prevention system 200 (FIG. 2) configured to utilize telemetry and other vehicle data to anticipate the formation of ice on the vehicle 10, and implement an ice mitigation strategy 222 to prevent formation of ice on the vehicle 10. Briefly, and as described in further detail below, the ice prevention system 200 receives sensor data 204 indicating a current environment 212 of the vehicle 10 and a predicted environment 214 of the vehicle 10, and generates an ice mitigation strategy 222 to prevent ice from forming on the vehicle 10. Thereafter, the ice mitigation strategy 222 is initiated while the vehicle 10 is parked. Notably, by preventing ice form forming on the vehicle 10, the ice prevention system 200 saves time for users of the vehicle 10, that otherwise would need to mechanically remove the ice.

The vehicle 10 includes data processing hardware 12 and memory hardware 14 storing instructions that when executed on the data processing hardware 12 cause the data processing hardware 12 to perform operations. The vehicle 10 may further include windshield wiper blades 16, door handles and locks 18, a cover 20 (e.g., a fuel tank cover, a charging port cover, etc.), and one or more windows 22 each in communication with the data processing hardware 12. The wiper blades 16 may be configured to actuate at configurable speeds and intervals. The door handles 18 and the cover 20 may each be configured to move in and out at configurable intervals. Likewise, the one or more windows 22 may be configured to open and close at configurable intervals and heights. As will be described further below, the components of the vehicle (e.g., wiper blades 16, door handles and locks 18, covers 20, and windows 22) may be prone to freezing in place when covered in ice. Accordingly, cyclically activating these components prevents ice from forming on the components, thereby allowing the components to maintain free movement in icy conditions.

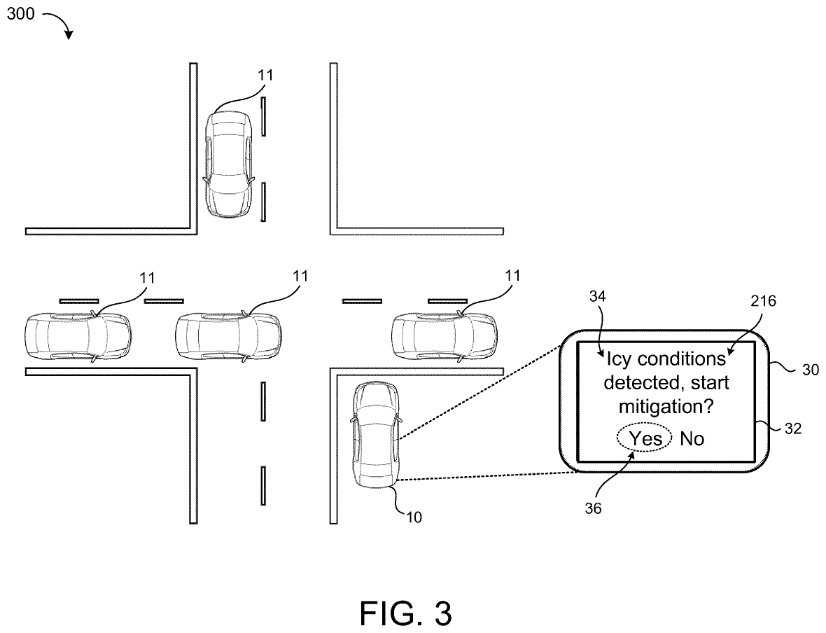

As shown, the vehicle 10 is further in communication with the remote system 60 via the network 40. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the ice prevention system 200 is shared across the vehicle 10 and the remote system 60. Additionally, the vehicle 10 includes a sensor system 24 configured to capture sensor data 202 within the vehicle 10 and within an environment 26 of the vehicle 10. The vehicle 10 may continuously, or at least during periodic intervals, receive the sensor data 202 captured by the sensor system 24 to determine a current environment 212 of the vehicle 10 and a predicted environment 214 of the vehicle 10. The sensor data 202 may include current weather conditions for the location that the vehicle 10 is parked, future weather predictions for the location of the vehicle 10, as well as third party data. For example, the sensor data 202 may include an outside temperature of the environment 26 of the vehicle 10, a cabin temperature of the vehicle 10, precipitation in the environment of the vehicle 10, cloud coverage in the environment 26 of the vehicle 10, the dew point of the environment 26 of the vehicle 10, the humidity of the environment 26 of the vehicle 10, a location of the vehicle 10 (e.g., covered or exposed parking, parked close to a busy road, etc.), a wind direction of the environment 26 of the vehicle 10, and third party traffic data of other vehicles 11 (FIG. 3) relative to the vehicle 10. In some examples, the sensor data 202 further includes image data and audio data capturing the environment 26 of the vehicle 10. Optionally the sensor data 202 includes a vehicle context (e.g., parked, on, off, etc.).

Referring to FIGS. 1 and 2, the ice prevention system 200 is configured to generate the ice mitigation strategy 222 and includes an environment detector 210 and an ice mitigation model 220. Additionally, the ice prevention system 200 has access to an ice prevention data store 230 that resides on the memory hardware 14 of the vehicle 10 and/or the memory hardware 64 of the remote system 60. The ice prevention data store 230 may include a corpus of previously generated ice mitigation strategies 222 that the ice prevention system 200 may access when generating the ice mitigation strategy 222. In other words, in instances where current sensor data 202 is similar to previously received sensor data 202, rather than generating a new ice mitigation strategy 222, the ice prevention system 200 may initialize a previously generated ice mitigation strategy 222 that was successful with the similar sensor data 202.

The environment detector 210 is configured to detect whether the vehicle 10 is parked in an unenclosed location (e.g., an uncovered location, a covered location open to the environment 26, etc.). For example, the environment detector 210 may receive the sensor data 202 as input and detect whether the vehicle 10 is parked in an unenclosed location based on the sensor data 202. In other implementations, the environment detector 210 may receive an unenclosed parking notification 204 indicating that the vehicle 10 is in an unenclosed location. For example, the environment detector 210 may receive the unenclosed parking notification 204 from an external system that monitors vehicles in the environment 26 and generates the unenclosed parking notification 204 when it detects that the vehicle 10 is parked in an unenclosed location.

With continued reference to FIG. 2, the environment detector 210 receives the sensor data 202 indicating the current environment 212 of the vehicle 10 and the predicted environment 214 of the vehicle 10 and determines, based on the sensor data 202, whether ice prevention for the vehicle 10 is needed to prevent ice from forming on the vehicle 10. For example, the sensor data 202 may indicate that the current environment 212 includes an outside temperature of the vehicle 26 that is less than freezing and active precipitation. Here, the environment detector 210 determines that ice is likely to form on the vehicle 10 and that ice prevention is necessary. In other implementations, the sensor data 202 indicates that the current environment 212 includes a high humidity in the environment 26, and the predicted environment 214 that the outside temperature of the environment 26 will drop. In this instance, the environment detector 210 determines that ice is likely to form on the vehicle 10 and that ice prevention is necessary. Similarly, the sensor data 202 may indicate that that the current environment 212 does not include precipitation or cloud cover, but the predicted environment 214 is freezing temperatures and/or precipitation. Here, the environment detector 210 determines that ice is likely to form on the vehicle 10 and that ice prevention is necessary. Notably, these are merely exemplary current environments 212 and predicted environments 214 that may cause the environment detector 210 to determine that ice mitigation is necessary. The environment detector 210 may use other combinations of sensor data 202 to determine whether ice prevention for the vehicle 10 is needed to prevent ice from forming on the vehicle 10.

When the environment detector 210 determines, based on the sensor data 202, that ice prevention for the vehicle 10 is needed, the environment detector 210 may generate a notification 216 to a user of the vehicle 10 notifying the user that conditions are favorable for ice formation. For example, the environment detector 210 generates, for output to a user of the vehicle 10, the notification 216 indicating that ice prevention for the vehicle 10 is needed. In some implementations, the notification 216 is displayed on a screen of a user device (e.g., a mobile device, a tablet, smart glasses, etc.) in communication with the data processing hardware 12 of the vehicle 10. Additionally or alternatively, the notification 216 is displayed on a user interface (e.g., a vehicle infotainment screen) of the vehicle 10.

The ice mitigation model 220 is configured to receive the sensor data 202 indicating the current environment 212 of the vehicle 10 and the predicted environment 214 of the vehicle 10, and generate the ice mitigation strategy 222 for the vehicle 10. Put differently, the ice prevention system 200 executes the ice mitigation model 220 that receives, as input, the sensor data 202 indicating the current environment 212 of the vehicle 10 and the predicted environment 214 of the vehicle 10 and generate, as output, the ice mitigation strategy 222 for the vehicle 10. The ice mitigation model 220 may further receive, as input, one or more of a schedule 224 of a user of the vehicle 10, a start time of precipitation for the location of the vehicle 10 while the vehicle 10 is parked, and an end time of the precipitation for the location of the vehicle 10 when the vehicle 10 is parked. Notably, the received sensor data 202 indicating the predicted environment 214 of the vehicle 10 may include the start and end times of precipitation.

In some implementations, the ice mitigation model 220 further receives a power source 26 (also referred to as a vehicle charge 26) of the vehicle 10. In implementations where the power source 26 of the vehicle 10 exceeds a threshold (i.e., has enough power to perform ice prevention), the ice mitigation model 220 proceeds to generate the ice mitigation strategy 222. Alternatively, when the power source 26 of the vehicle 10 does not exceed the threshold, the ice prevention system 200 may defer execution of the ice mitigation model 220 (e.g., until the power source 26 is replenished). Notably, the threshold may be configurable (i.e., during assembly of the vehicle 10) and may be unique to the model of the vehicle 10.

In some implementations, the ice mitigation strategy 222 includes cycling one or more of the windows 24 of the vehicle 10, the wiper blades 26 of the vehicle 10, the door handles and locks 18 of the vehicle 10, and the cover 20 of the vehicle 10. Notably, these cycling operations of various moveable external components of the vehicle 10 may prevent ice from covering the vehicle 10 and building up to the point that movement of the external components is limited such that the components may be damaged. For example, the ice mitigation strategy 222 for sensor data 202 indicating a current environment 212 of freezing outside temperatures and precipitation may include cycling between partially opening the windows 24 and closing the windows 24 at a selectable frequency, between locking and unlocking the locks 18 at a selectable frequency, and between moving the handles 18 in and out at a selectable frequency. In other examples, the ice mitigation strategy 222 for sensor data 202 indicating a current environment 212 of high humidity and a predicted environment 214 of outside temperatures dropping may include cycling the windshield wipers when the outside temperature drops below freezing at a selectable frequency, cycling between partially opening the windows 24 and closing the windows 24 at a selectable frequency, cycling between locking and unlocking the locks 18 at a selectable frequency, and cycling between moving the handles 18 in and out at a selectable frequency. Similarly, the ice mitigation strategy 222 for sensor data 202 indicating a current environment 212 of no precipitation and no cloud cover and a predicted environment 214 of outside temperatures dropping may include cracking the windows 22 until the cabin temperature of the vehicle 10 is the same as the outside temperature and then closing the windows 22, cycling the windshield wipers when the outside temperature drops below freezing at a selectable frequency, cycling between partially opening the windows 24 and closing the windows 24 at a selectable frequency, cycling between locking and unlocking the locks 18 at a selectable frequency, and cycling between moving the handles 18 in and out at a selectable frequency.

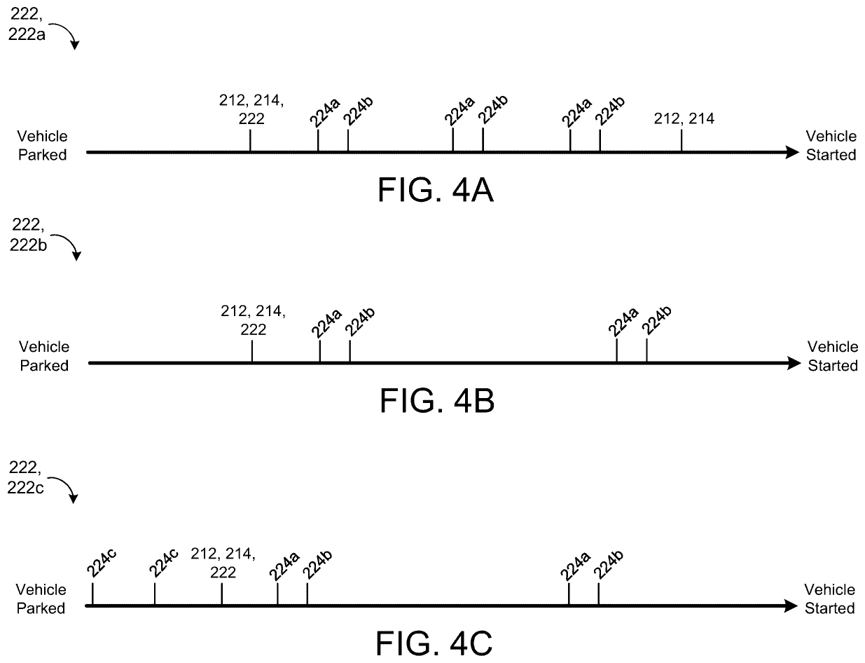

With particular reference to FIGS. 4A-4C, example ice mitigation strategies 222a-222c are shown. Here, each ice mitigation strategy 222 shows a timeline t indicating the time between a vehicle 10 parking (i.e., in an unenclosed location) and when the vehicle 10 is started again. Referring to FIG. 4A, shortly after parking, the sensor data 202 may indicate that the current environment 212 includes a below freezing outside temperature and precipitation. Here the ice mitigation model 220 generates the ice mitigation strategy 222a that includes the cycle 224a of actuating the wipers 16 and the cycle 224b of activating the handles and locks 18. Thereafter, the ice prevention system 200 receives sensor data 202 indicating that the current environment 212 includes above freezing outside temperatures, and suspends the ice mitigation strategy 222a.

In FIG. 4B, shortly after parking, the sensor data 202 may indicate that the current environment 212 includes below a freezing outside temperature and high humidity. Here, the ice mitigation model 220 generates the ice mitigation strategy 222b that includes the cycle 224a of actuating the wipers 16 and the cycle 224b of activating the handles and locks 18. The ice mitigation strategy 222a may alternate the cycles 224a and 224b until the vehicle 10 is started.

Referring to FIG. 4C, the ice mitigation model 220 generates the ice mitigation strategy 222c that includes a cycle 224c of cracking the windows 22 and then closing the windows 22 (i.e., when the temperature inside the vehicle 10 is the same as the outside temperature). Thereafter, the sensor data 202 may indicate that the current environment 212 includes no precipitation or cloud coverage, and a predicted environment 214 of falling outside temperatures. Here, the ice mitigation model 220 may update the ice mitigation strategy 222c to include the cycle 224a of actuating the wipers 16 and the cycle 224b of activating the handles and locks 18. The ice mitigation strategy 222a may alternate the cycles 224a and 224b until the vehicle 10 is started. Notably, because the sensor data 202 does not include precipitation, the ice mitigation strategy 222c may use the cycles 224a, 224b with less frequency.

Referring to FIG. 3, in some implementations, the vehicle 10 may include or be in communication with a user interface 30 including a graphical user interface (GUI) 32. The GUI 32 may facilitate a user of the user interface 30 approving the use of the ice mitigation strategy 222 using the GUI 32. In the example, the sensor data 202 may indicate that the current environment 212 includes third party user data that the vehicle 10 is parked near a busy street with multiple other vehicles 11 passing by. Here, the other vehicles 10 may cause additional precipitation to be directed toward the vehicle 10 such that the environment detector 210 determines that ice prevention is needed for the vehicle 10. As shown, the GUI 32 renders/displays a graphical element representing a prompt for the user “Icy conditions detected, start mitigation?” and the graphical elements for the user to select “Yes” or “No” as a selectable option 36 that, when selected, authorizes/requests the vehicle 10 to generate the ice mitigation strategy 222. As used herein, the GUI 32 may receive user input indications via any one or of touch, speech, gesture, gaze, and/or an input device (e.g., mouse or stylus). In response to a user of the vehicle 10 selecting the selectable option 36 of “Yes,” the ice prevention system 200 (i.e., via the ice mitigation model 220) generates the ice mitigation strategy 222 for the vehicle 10, and initiates the ice mitigation strategy 222 for the vehicle 10 while the vehicle 10 is parked.

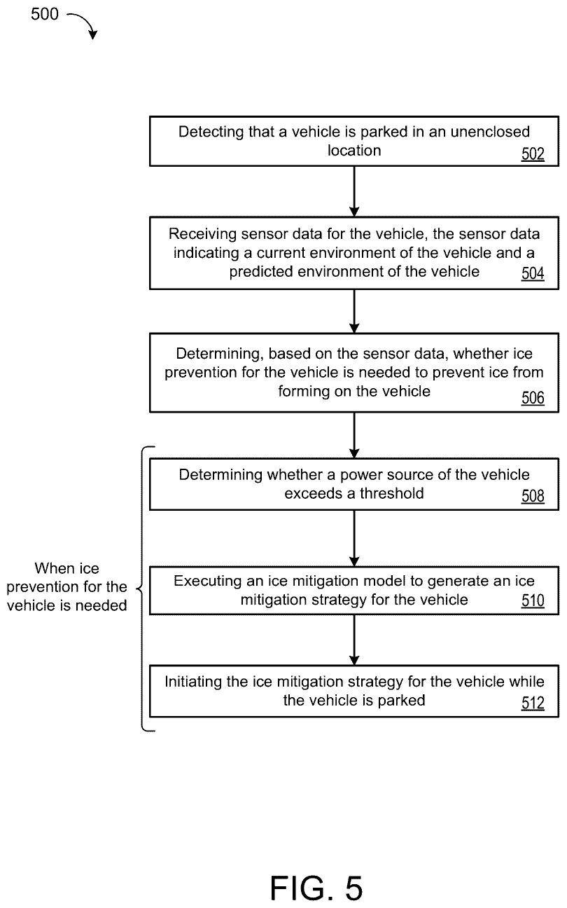

FIG. 5 includes a flowchart of an example arrangement of operations for a method 500 of ice prevention via telemetry and other data elements. The method 400 may be described with reference to FIGS. 1-4C. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

The method 500 includes, at operation 502, detecting that a vehicle 10 is parked in an unenclosed location. At operation 504, the method 500 also includes receiving sensor data 202 for the vehicle 10. The sensor data 204 indicates a current environment 212 of the vehicle 10 and a predicted environment of 214 of the vehicle 10. The method 500 also includes, at operation 506, determining, based on the sensor data 204, whether ice prevention for the vehicle 10 is needed to prevent ice from forming on the vehicle 10.

When ice prevention for the vehicle 10 is needed, the method 500 further includes operations 508-512. At operation 508, the method 500 includes determining whether a power source 26 of the vehicle 10 exceeds at threshold. The method 500 also includes, at operation 510, executing an ice mitigation model 220 to generate an ice mitigation strategy 222 for the vehicle 10. At operation 512, the method 500 further includes initiating the ice mitigation strategy 222 for the vehicle 10 while the vehicle 10 is parked.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
detecting that a vehicle is parked in an unenclosed location;
receiving sensor data for the vehicle, the sensor data indicating a current environment of the vehicle and a predicted environment of the vehicle;
determining, based on the sensor data, whether ice prevention for the vehicle is needed to prevent ice from forming on the vehicle; and
when ice prevention for the vehicle is needed:
determining whether a power source of the vehicle exceeds a threshold;
executing an ice mitigation model to generate an ice mitigation strategy for the vehicle; and
initiating the ice mitigation strategy for the vehicle while the vehicle is parked.

2. The method of claim 1, wherein the operations further comprise, after determining that ice prevention for the vehicle is needed, generating, for output to a user of the vehicle, a notification indicating that ice prevention for the vehicle is needed.

3. The method of claim 2, wherein the notification is displayed on a screen of a user device in communication with the data processing hardware.

4. The method of claim 2, wherein the notification is displayed on a user interface of the vehicle.

5. The method of claim 1, wherein the sensor data for the vehicle comprises one or more of:
an outside temperature;
a cabin temperature of the vehicle;
precipitation;
cloud coverage;
dew point;
humidity;
location;
wind direction; and
third party traffic data.

6. The method of claim 1, wherein the predicted environment of the vehicle comprises weather predictions for a location of the vehicle while the vehicle is parked.

7. The method of claim 1, wherein the ice mitigation strategy comprises cycling one or more of:
windows of the vehicle;
wiper blades of the vehicle;
door handles of the vehicle; and
a cover of the vehicle.

8. The method of claim 1, wherein executing the ice mitigation model to generate the ice mitigation strategy for the vehicle comprises receiving one or more of:
a schedule of a user of the vehicle;
a start time of precipitation for a location of the vehicle while the vehicle is parked; and
an end time of the precipitation for the location of the vehicle while the vehicle is parked.

9. The method of claim 1, wherein executing the ice mitigation model to generate the ice mitigation strategy for the vehicle is based on determining that the power source of the vehicle exceeds the threshold.

10. The method of claim 1, wherein the operations further comprise, when the power source of the vehicle does not exceed the threshold, deferring execution of the ice mitigation model.

11. A system comprising:
data processing hardware; and
memory hardware in communication with the data processing hardware, the memory hardware storing instructions that when executed on the data processing hardware cause the data processing hardware to perform operations comprising:
detecting that a vehicle is parked in an unenclosed location;
receiving sensor data for the vehicle, the sensor data indicating a current environment of the vehicle and a predicted environment of the vehicle;
determining, based on the sensor data, whether ice prevention for the vehicle is needed to prevent ice from forming on the vehicle; and
when ice prevention for the vehicle is needed:
determining whether a power source of the vehicle exceeds a threshold;
executing an ice mitigation model to generate an ice mitigation strategy for the vehicle; and
initiating the ice mitigation strategy for the vehicle while the vehicle is parked.

12. The system of claim 11, wherein the operations further comprise, after determining that ice prevention for the vehicle is needed, generating, for output to a user of the vehicle, a notification indicating that ice prevention for the vehicle is needed.

13. The system of claim 12, wherein the notification is displayed on a screen of a user device in communication with the data processing hardware.

14. The system of claim 12, wherein the notification is displayed on a user interface of the vehicle.

15. The system of claim 11, wherein the sensor data for the vehicle comprises one or more of:
an outside temperature;
a cabin temperature of the vehicle;
precipitation;
cloud coverage;
dew point;
humidity;
location;
wind direction; and
third party traffic data.

16. The system of claim 11, wherein the predicted environment of the vehicle comprises weather predictions for a location of the vehicle while the vehicle is parked.

17. The system of claim 11, wherein the ice mitigation strategy comprises cycling one or more of:
windows of the vehicle;
wiper blades of the vehicle;
door handles of the vehicle; and
a cover of the vehicle.

18. The system of claim 11, wherein executing the ice mitigation model to generate the ice mitigation strategy for the vehicle comprises receiving one or more of:
a schedule of a user of the vehicle;
a start time of precipitation for a location of the vehicle while the vehicle is parked; and
an end time of the precipitation for the location of the vehicle while the vehicle is parked.

19. The system of claim 11, wherein executing the ice mitigation model to generate the ice mitigation strategy for the vehicle is based on determining that the power source of the vehicle exceeds the threshold.

20. The system of claim 11, wherein the operations further comprise, when the power source of the vehicle does not exceed the threshold, deferring execution of the ice mitigation model.
